(19) United States
(12) Patent Application Publication
(10) Pub. No.: US 2015/0294252 A1
(43) Pub. Date: Oct. 15, 2015

(54) METHOD FOR STOCK-KEEPING AND/OR PRODUCTION OPTIMIZATION AND METHOD FOR PRODUCING A VEHICLE INTERIOR TRIM PART

(71) Applicant: JOHNSON CONTROLS GMBH, Burscheid (DE)

(72) Inventor: Jelle Van Der Haak, Graz (AT)

(21) Appl. No.: 14/430,618

(22) PCT Filed: Sep. 23, 2013
(86) PCT No.: PCT/EP2013/069727

§ 371 Date: Mar. 24, 2015

(30) Foreign Application Priority Data
Sep. 25, 2012 (EP) 12006700.4

(51) Int. Cl. G06Q 10/06; G06Q 10/08

(52) U.S. Cl. CPC G06Q 10/06315; G06Q 10/087

(57) ABSTRACT

A method for stock-keeping and/or production optimization for at least one product and components thereof, comprising the provision of a first computer means connected to at least one first database; at least one second computer means connected to at least one second database; wherein the second database is connected to the first computer and each second computer means is connected to the first database, wherein the first and/or second databases has/have data about current inventory of the product and/or its components and production planning therefor, and each first computer means identifies all components of the product and the associated databases; each first computer means ascertains the current inventory; each first computer means ascertains the production planning; each first computer means compares the current inventory and the production planning with at least one order for the product, which is present in the database and/or another system component.

The present invention relates to a method for stock-keeping and/or production optimization for at least one product and the components thereof, wherein the product is manufactured from at least two components.

Supply chains in which components and/or products are produced on the basis of division of labor are known in industry. A fundamental disadvantage of these supply chains is that the individual production installations can only react to orders. This results in time delays, since each production installation separately needs to perform calculations of requirements in the course of production planning. In addition, classic supply chains lead to what is known as “whiplash effect”. Thus, demand fluctuations, that is to say order fluctuations, within a supply chain quickly escalate, so that bottlenecks and/or overproduction arise(s).

It is an object of the present invention to eliminate the disadvantages of the prior art.

The object is achieved by a method for stock-keeping and/or production optimization for at least one product, wherein the product is manufactured from at least two components, comprising the provision of:
at least one first computer means that is connected to at least one first database by means of a data connection and
at least one second computer means that is connected to at least one second database by means of a data connection; wherein the second database is connected to the first computer means by means of a data connection and each second computer means is connected to the first database by means of a data connection, wherein the first and/or second databases have data about the current inventory of the product and/or the components thereof and the production planning therefor,
   and at least the following steps:
each first computer means identifies all components of the product and preferably also the associated databases;
each first computer means ascertains the current inventory of the product and/or the components thereof;
each first computer means ascertains the production planning for the product and/or the components thereof;
each first computer means compares the current inventory and the production planning with at least one order for the product, which is present in the database and/or another system component connected to the first computer means.

In this case, a computer means is at least one numerate unit, consisting of at least one CPU and possibly a data memory. The databases may themselves in turn be data memories and be located in a housing with the computer means, but also accommodated separately therefrom. Said data memories may be volatile and/or nonvolatile data memories.

Preferably, a plurality of first and/or a plurality of second computer means are provided. Particularly preferably, each computer means is associated here with a different production installation or with a different manufacturer in a supply chain.

The data connections can be made by wired connection, preferably via a local area network (LAN), particularly preferably by an Intranet, quite particularly preferably via a wide area network (WAN) or else preferably via a global area network (GAN), particularly via the Internet.

Additionally or alternatively, all or some of the data connections can also be made via a wireless connection, preferably a wireless local area network (WLAN, in line with a standard based on IEEE-802.11), particularly preferably via Bluetooth (IEEE 802.15.1).

The data connections can be made in unencrypted form, but preferably all data connections are made in encrypted form.

According to the invention, the method comprises at least the steps explained below: first of all, a first computer means sends a command to one and/or all database(s) via the data connections in order to identify all components of the product to be produced and preferably also the databases of the production installations in which said components are produced. By way of example, this can be accomplished by virtue of the computer means searching the inventory lists and/or materials lists for the one or more products and preferably using the data stored therein to identify the components associated with a product, and particularly preferably the databases of the associated production installations. These stored data are preferably supply agreements (scheduling agreements), but may also be other keys used within the supply chain.

Preferably, components also mean subcomponents. The inventory list and/or materials list is particularly also a materials parts list.

In the next step, the computer means ascertains the current inventory of the product and/or the components thereof. In this case, “current” means at the time t₀ at which the method according to the invention is performed. To this end, it searches the databases, particularly the inventory lists and/or material lists, of the relevant production installations for the inventories of the products and/or components produced therein.

Depots mean both mobile and static depots. In particular, they also cover those products and/or components in the inventory that are currently being transported within the supply chain.

Next, or in parallel therewith or prior thereto, the computer means ascertains the production planning for the product and/or the components thereof. This is accomplished again by searching the databases for the production planning data of the relevant production installations. By way of example, the computer means thus establishes that a contract for the supply of a particular number of one or more components between one or more of the production installations for the product and/or the components thereof falls due at a particular instant.

In the next step, the computer means compares the inventory at the key date t_{B} for at least one order with the quantity of the order. The key date T_{B} for an order is preferably the due date for this order. To this end, the computer means combines the current inventory of the product and/or the components thereof with the inventory arising from the production planning, based on the key date.

Preferably, the production planning comprises at least one supply agreement, particularly a quantity of the product and/or at least one of the components thereof that is to be supplied at a time t_{L}.

Preferably, the production planning comprises, based on the key date t_{B}, the cumulated order quantities and/or instants for the supply agreements at the at least one instant t_{L}.

In this case, the key date for the order t_{B} is present in the database connected to the first computer means, or in a different database, directly or indirectly linked to the first computer means, or in another system component that is directly or indirectly connected to the first computer means.

It is clear to a person skilled in the art that the roles of the computer means can be interchanged, so that each computer means in the supply chain can carry out the method according to the invention.

In addition, the steps for determining the respective inventory(ies) at the times t₀ and t_{L} and/or t_{B} can take place either simultaneously or in any order.

Quite particularly preferably, one and/or more computer means has/have one input means and/or at least one display apparatus connected to it/them, so that all and/or some of the method steps and/or the result can be displayed and/or external method parameters, such as an order and/or key dates, for example, can be input.

Preferably, an order comprises an order quantity for the product and/or at least one component at the order instant t_{B}. Particularly preferably, the supply agreements also correspond to orders, in that case based on the agreed delivery instants t_{L}.

Preferably, an order comprises at least one of the following data: an order quantity, particularly a quantity of the product and/or of at least one of the components thereof that is to be supplied, an order date, corresponding to a key date for the order t_{B} or t_{L}, an identification number and/or a designation for the product and/or the at least one component for the purpose of identification in the inventory list and/or materials list.

A display apparatus is preferably a printer, particularly preferably a screen, but may also be another display means with which a person skilled in the art is familiar.

Particularly preferably, the computer means can also ascertain the excess inventory of the product and/or the components thereof, that is to say the number of days and/or other time periods for which the inventory in question is still sufficient before the depot is empty. Quite particularly preferably, the excess inventory is determined in relation to the order on the key date t_{B}. In this case, the excess inventory essentially corresponds to the quotient of the current inventory and the total quantity of the order, with the quantity of the order also being multiplied by a factor, said factor corresponding to the period of the order. Hence, the denominator of the excess inventory corresponds to the consumption, based on a particular period of time.

According to a further advantageous embodiment, the excess inventory can also be specified on the basis of any period other than for the order with the key date t_{B}.

According to yet a further advantageous embodiment of the method according to the invention, the computer means also computes the cumulative quantities of the product and/or the components thereof, particularly both the actual cumulative quantities and the target cumulative quantities, which essentially correspond to the quantities produced (actual cumulative quantities) and the quantities to be supplied (target cumulative quantities), respectively. Particularly preferably, the computer means uses the cumulative quantities in order to optimize the stock-keeping.

According to an advantageous embodiment of the method according to the invention, the computer means outputs a warning, particularly via the at least one display apparatus, if the ascertained excess inventory is insufficient up to the at least one key date for the order t_{B}.

According to the invention, a method for producing a vehicle interior trim part is furthermore proposed that, in addition to the method described above, additionally also contains the steps that the computer means of a production installation optimizes the production planning the data ascertained in the course of the method according to the invention and delivers the resulting data to at least one other, second, computer means in the supply chain. Particularly preferably, the computer means ascertains the data resulting from the production optimization on at least one production unit connected to the computer means.

Preferably, said second computer means thus optimizes the process parameters of a connected production unit and then forwards the optimized process parameters to the production unit via the data connections. Particularly preferably, the second computer means and/or the production unit connected thereto optimizes the inventory by placing material orders or canceling planned and/or existent material orders or adjusting the quantities thereof for delivery. Quite particularly preferably, production can also be increased or lowered. Also quite particularly preferably, the second computer means optimizes the process parameters and the inventory. Quite particularly preferably, these optimized data are again stored in a database and/or returned to the first computer means so that these data can be taken into account when the method according to the invention is next performed.

This can be achieved by all parameters for changing production that are known to a person skilled in the art.

According to an advantageous embodiment, the first and/or second computer means and/or the production unit performs these steps only after confirmation by a user.

Preferably, some and/or a plurality of or all data that have been described in one of the described methods or the advantageous embodiments thereof are stored. This storage is performed by the first and/or second computer means and, quite particularly preferably, will be effected in one and/or more arbitrary databases. In particular, the computer means store the data in the databases that are directly connected to them, which relate to the connected production installation directly.

According to one advantageous embodiment, the executing computer means outputs an error message via at least one connected display apparatus in the event of an error in the method. Additionally or alternatively, the executing computer means prompts the method to be restarted and/or parameters to be input, particularly at least one parameter for an order.

It is also conceivable for the language used in the method and/or the units used in the method to be stipulated before the method begins. It is thus preferably possible for the method to be used by product and/or component manufacturers in a supply chain in different countries. Preferably, the unit used may be a desired currency. Particularly preferably, physical units can be displayed using the metric system or using the Anglo-American system, for example.

According to a further advantageous form of the method, the computer means check(s), prior to access to a database and/or a computer means, whether access authorization is available. Preferably, it terminates the method if there is no or insufficient access authorization available. Particularly preferably, it then outputs an error message. Quite particularly preferably, this and/or different steps and/or elements in the method require(s) different authorizations, however.

Preferably, the first computer means and/or the second computer means has/have access to all databases of all installations in the supply chain, but particularly preferably the access is configured such that a user has access only to the end result of the method, that is to say particularly is unable to view all data, such as inventories and/or excess inventories and/or supply agreements.

Preferably, the method according to the invention is limited to one, two, three, four, five, six or more levels of at least one supply chain.

It would thus be conceivable for just the computer means of the end product manufacturer, or the OEM (original equipment manufacturer), also to be able to see the altered process parameters and/or all components and/or the product, while other installations have only limited access to all data.

Preferably, at least the first computer means has at least access to the inventory lists and/or materials lists for at least one portion of the supply chain, particularly preferably the whole supply chain, and/or to the inventories for at least one portion of the supply chain, quite particularly preferably the whole supply chain, and/or the order quantity.

This is intended to be understood to mean particularly that a manufacturer or an installation in the supply chain can perform the method only for those products and/or components for which it is connected to other parts of the supply chain by means of supply agreements.

In particular, the inventories are specified using excess inventories and/or are stored in the databases in the form of excess inventories.

Preferably, empirical values for quantities to be supplied are used instead of order quantities and/or supply agreements. This advantageously allows the method according to the invention to be performed even without specific or current orders from a customer.

Preferably, the computer means outputs at least one of the following values, particularly via the display apparatus, following conclusion of the method: the net demand of the OEM, the inventories of the product and/or at least one component from at least one manufacturer or at least installation in the supply chain, the excess inventory for the product and/or at least one component for at least one manufacturer or an installation in the supply chain, an aggregated excess inventory for the whole supply chain, a monetary equivalent of the inventory of at least one manufacturer or of an installation in the supply chain, an aggregated monetary equivalent of the inventory of the whole supply chain and/or the product and/or at least one component that is relevant to the installation or manufacturer associated with the computer means.

Preferably, a maximum excess inventory is prescribed for the computer means, wherein, following performance of the method, the computer means additionally displays and/or stores those databases and/or installations separately whose excess inventory exceeds the prescribed value.

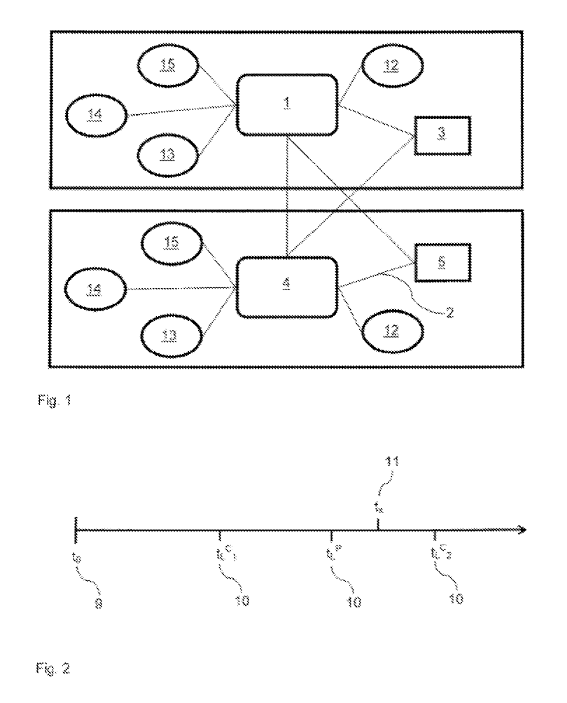

The inventions are explained below with reference to FIGS. 1-11. These explanations are merely by way of example and do not restrict the general inventive concepts. The explanations apply to all subjects of the present invention in equal measures.

FIG. 1 shows a block diagram of a possible embodiment of the system.

FIG. 2 shows an exemplary, schematic illustration of the various relevant times in the method.

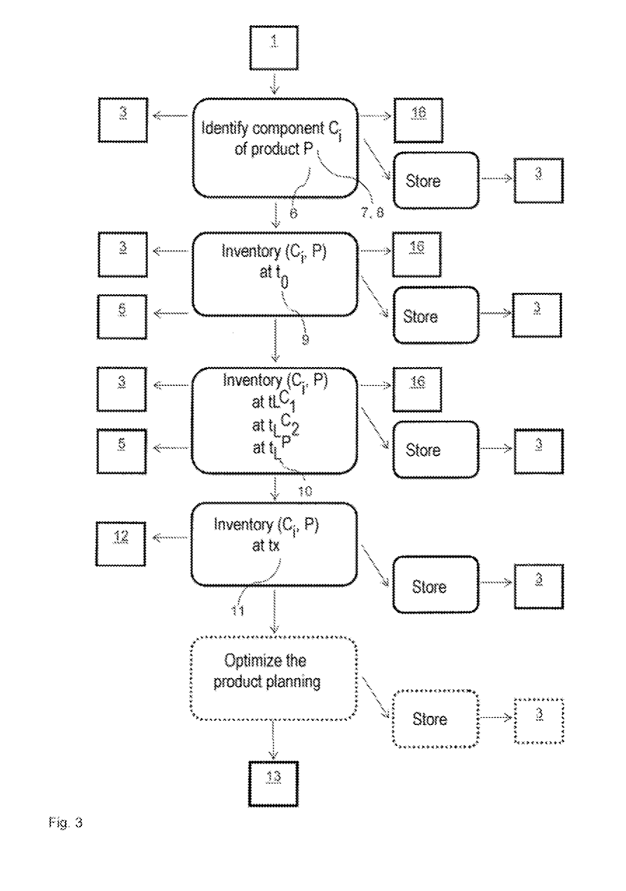

FIG. 3 shows a possible form of the method in the form of a flowchart.

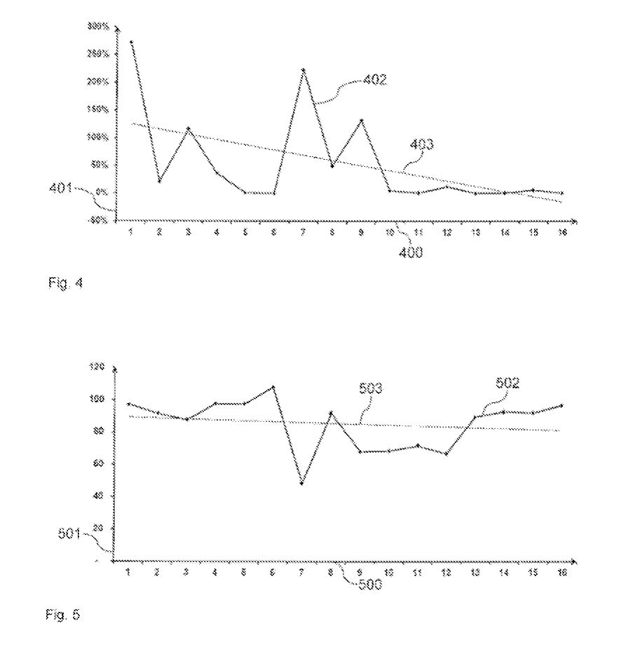

FIG. 4 shows an exemplary graph for a supply chain following introduction of the method according to the invention.

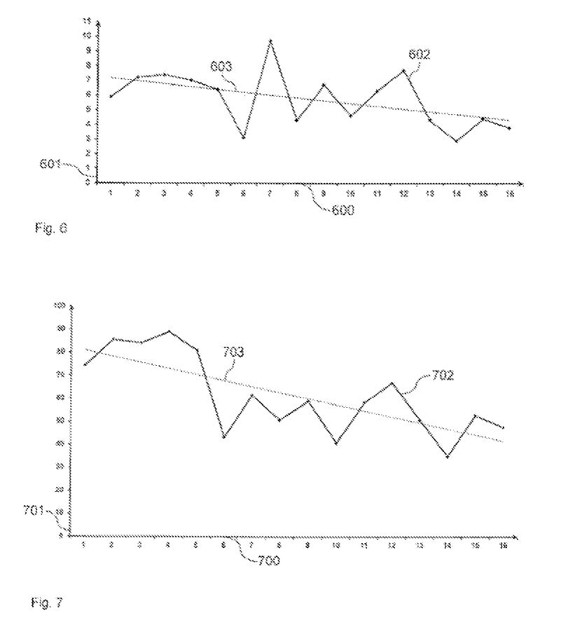

FIG. 5 shows a further exemplary graph for a supply chain following introduction of the method according to the invention.

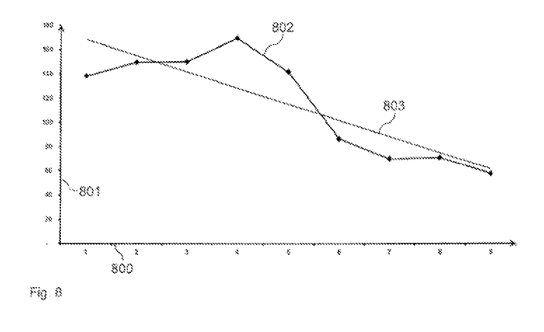

FIG. 6 shows yet a further graph for a supply chain following introduction of the method according to the invention.

FIG. 7 shows another exemplary graph for a supply chain following introduction of the method according to the invention.

FIG. 8 shows an exemplary graph for a further supply chain following introduction of the method according to the invention.

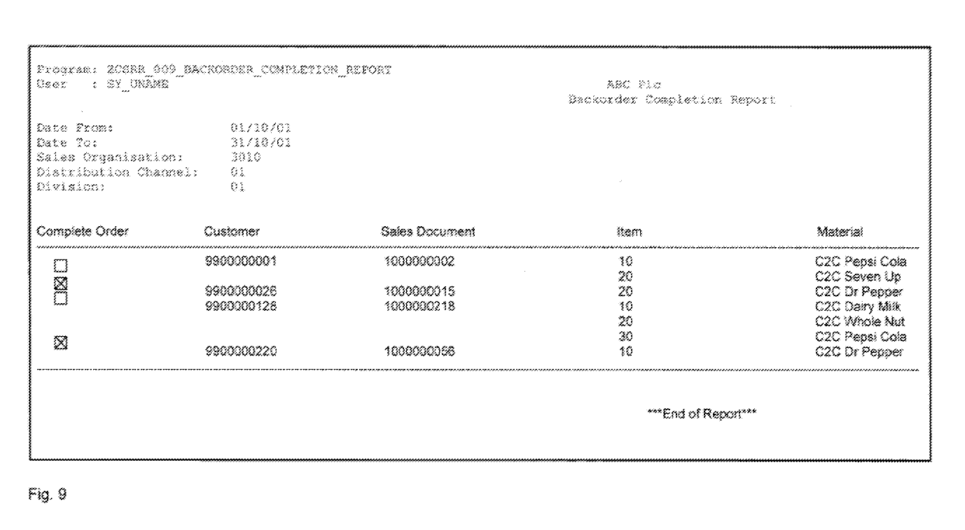

FIG. 9 shpws an exemplary output from a display apparatus for the method according to the invention.

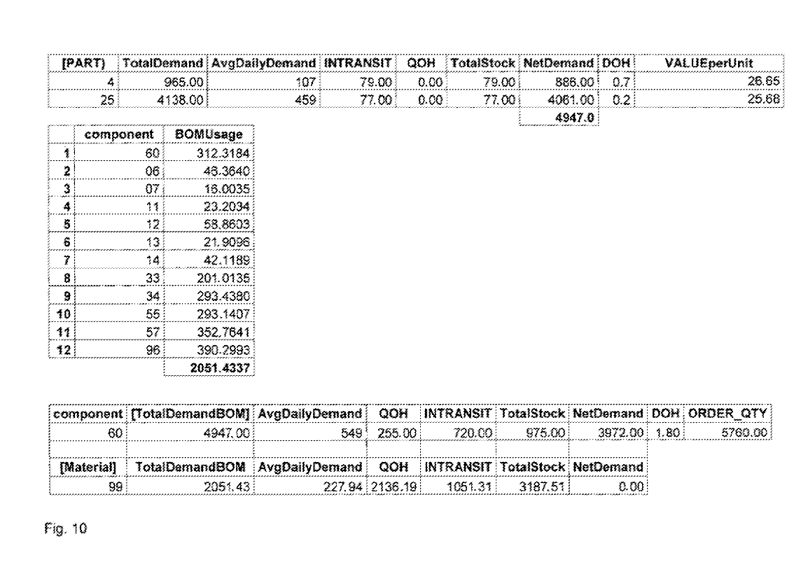

FIG. 10 shows a further exemplary embodiment of the method according to the invention.

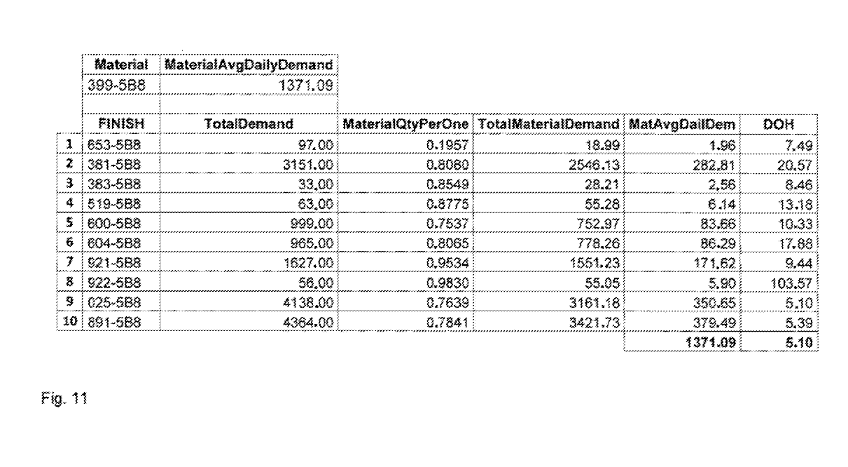

FIG. 11 shows yet a further embodiment of the method according to the invention.

A detailed description of the invention in the form of possible embodiments is provided below with reference to the drawings.

FIG. 1 shows two systems, as they communicate with one another in the method. These may be the IT systems of the production installations of the product and/or component manufacturers, for example. Preferably, more than two systems communicate with one another. Each system consists of a centrally depicted first or second computer means 1, 4 and, in each case, a database 3, 5 connected to the computer means 1, 4. The first or second computer means 1, 4 are each connected to all components of the system by means of data connections 2.

The first and/or second computer means 1, 4 also has/have, apart from the database 3, 5, optionally the controller of a production unit 13 and/or the depot manager thereof, an input means 14 and/or a display apparatus 15 connected to it/them. If required, further system components 12 can be connected to the computer means.

The systems are networked to one another via the computer means 1, 4. Preferably, the computer means 1, 4 are each directly connected to the databases 3, 5 of the respective other system.

FIG. 2 uses a timeline to show the times that are relevant to the method by way of example. The instant at which the method is carried out or started is denoted by t₀ 9. Over the course of the method, the computer means 1 ascertains, if necessary, all components required for a product and the production planning for the product 6 and the components 7, 8 thereof. Usually, different supply agreements and hence different supply and/or provisioning deadlines are available for the product and for the components. These are each indicated by t_{L}ⁱ 10. The key date for an order for the product is denoted by t_{B} 11.

Preferably, the method is also used for more than one product and/or more than two components simultaneously.

FIG. 3 schematically outlines the course of such a method according to a preferred embodiment. The computer means 1 first of all identifies all components 7, 8 of the product 6. To this end, the computer means 1 accesses the database 3 and/or the inventory list 16, the inventory list 16 being able to be in any database, which may be at any location, that is connected to the computer means 1, that is to say particularly also in the database 3.

In the next step, the computer means 1 ascertains the inventory of the product (6) and the components 7, 8 thereof at the time t₀ 9. To this end, the computer means 1 accesses all those databases whose production installations or production units produce the product 6 and/or one or more of the components 7, 8 thereof. Preferably, the computer means 1 stores the ascertained data, particularly preferably in the database 3.

Next, the computer means 1 ascertains the inventory of the product 6 and the components 7, 8 thereof at the time t_{L} 10. The procedure for this is precisely as described in the previous step. The products and/or components that are produced in addition to the current inventory up until the instant t_{L} 10 are taken into account for this. Preferably, the computer means 1 stores the ascertained data, particularly preferably in the database 3.

In the subsequent method step, the computer means 1 compares the ascertained or future inventories of the product 6 and the components 7, 8 thereof, based on the key date for one or more inbound or existent orders for the product, with, the ordered quantities t_{B} 11. Again, the computer means 1 preferably stores the ascertained data, particularly preferably in the database 3. The computer means 1 preferably reads the key date for the order 11 from the connected database 3 and/or from another connected system component 13. Particularly preferably, the key date is supplied by an input means 14.

According to an advantageous embodiment, it is preferred for the computer means 1 to optimize the production planning using the data obtained and particularly preferably to deliver the optimization data to one or more directly and/or indirectly connected production units 14. Quite particularly preferably, the computer means 1 stores the ascertained data, preferably in the database 3.

The optimization of the production planning is preferably optimization of the stock-keeping, the production and/or the merchandise management. Thus, the computer means determines the optimum product and/or component production figure as a function of the time that is needed for one or more existent order(s). Particularly preferably, the production of the production unit connected to the respective computer means is also optimized as well, for example by optimizing process parameters that are then sent via the data connections to the connected production unit and read by the latter and/or used for process control.

Alternatively or additionally, the respective computer means can also place and/or alter and/or cancel material orders, particularly for subcomponents. If, for example in anticipation of expected higher order quantities, too many subcomponents have been ordered, the computer means can modify the order for the subcomponents as appropriate, quite particularly preferably taking account of the supply terms, and/or it can reorder subcomponents so that no delays in production arise, but there is also no unnecessarily large stock of material.

The method described here can be performed in this or a similar form by all manufacturers in a supply chain. However, it is likewise conceivable for just particular manufacturers to be able to perform the method according to the invention and/or for all or some manufacturers not to be able to access all data from every manufacturer in the supply chain. Particularly in the case of supply chains with a large number of different manufacturers, it is advantageous if noncompeting manufacturers cannot view the whole production planning for their competitors, for example.

Particularly preferably, the method according to the invention is used for a supply chain of one manufacturer, so that the first computer means 1 has access to all required databases 3, 5, particularly to all materials lists or inventory lists 16. This greatest possible transparency within the supply chain allows optimal performance of the method according to the invention and hence best possible production control, for example.

FIG. 4 shows an exemplary graph 402 for a supply chain following introduction of the method according to the invention. The abscissa 400, i.e. the horizontal axis, has time plotted on it, based on the introduction of the method according to the invention in the supply chain. In this case, the units of time are indicated in periods, in this case in weeks. The ordinate 401, i.e. the vertical axis, indicates the relative change in demand between two production installations.

The general trend in this case is indicated by a regression line 403. It can be seen that although there are fluctuations in demand even following introduction of the method, these decrease over time and are significantly less than 10%. The steadier evolution in demand allows the production installation to plan better and for the longer term without holding large inventories. This shows that the method according to the invention can avoid a whiplash effect, as can be seen at the beginning of the measurements, that is to say in the left-hand part of the illustration.

For the original equipment manufacturer, this essentially means product inventories, and for secondary suppliers it essentially means component inventories.

However, the original equipment manufacturer can also produce and/or stock components 7, 8 and/or other manufacturers on the same or a different level of the supply chain can produce and/or store components 7, 8, subcomponents and/or the finished product 6.

In this case, the data shown in this and the subsequent graphs correspond to experimentally ascertained values for a part of a supply chain in which the method according to the invention has been implemented.

FIG. 5 shows a further exemplary graph 502 for a supply chain following introduction of the method according to the invention. In this case, the abscissa 500 again has weeks plotted on it, while the ordinate 501 has average daily sales figures plotted for a component from a manufacturer that is secondary in the supply chain to the original equipment manufacturer, and/or a further production installation in the supply chain.

In this case, the representation of the sales figures is chosen as an index representation 503 with a basic value of 100 units. If is striking in this case that the sales figures fall to begin with. This is caused by the production migration to the new method. The right-hand side of the illustration reveals a rise in the sales figures.

In addition, a regression line 503 is shown, according to which the sales figures fell slightly on average. On the one hand, this may be a statistical effect caused by the outlier in week 7. On the other hand, it is also possible for the better planning and lower stockage to mean that the sales figures fall somewhat at first and, in the long run, at least settle at a largely constant level or even rise again, at least when special effects such as seasonal sales increases or general consumption weakness are taken into account.

FIG. 6 shows yet a further graph 602 for a supply chain following introduction of the method according to the invention. While the representation of the abscissa 600 corresponds to the representation explained in connection with FIGS. 4 and 5, the ordinate 601 indicates the excess inventory in days. Again, a regression line 603 is shown that indicates the general trend.

It can be seen that the excess inventory falls over the period under consideration. This means that the various manufacturers in the supply chain now require only small inventories, since the method according to the invention means that the production planning for the whole supply chain can be viewed directly and if need be influenced in the event of a change in demand from a customer.

In particular, FIG. 6 needs to be interpreted in connection with FIG. 5. Thus, the excess inventory falls sharply in the right-hand portion of the graph 602 of FIG. 6, whereas, as indicated in FIG. 5, the sales figures rise.

In this case, it is clear to a person skilled in the art that these effects will turn out to be even more distinct when the method runs for a longer time, since the results shown also reveal migration effects, which are significant on account of the short period. The period under consideration, at approximately 16 weeks, is thus very short.

FIG. 7 shows another exemplary graph 702 for a supply chain following introduction of the method according to the invention. While the representation of the abscissa 700 corresponds to the representation explained above, that is to say indicates the time since the introduction of the method in weeks, the ordinate 701 indicates an arbitrarily normalized representation of the cumulated inventories.

As can clearly be seen, the inventories fall continuously over time. The magnitude of the gradient of the inventory evolution is very great in this case, i.e. the inventories fall more sharply than the sales figures in accordance with the illustration in FIG. 6.

The invention thus allows the whole supply chain to work with smaller inventories, which reduces stock-keeping costs, inter alia, and gives rise to lower follow-up costs in the event of production migrations and/or order cancelations.

FIG. 8 shows an exemplary graph 802 for a further supply chain following introduction of the method according to the invention. The representation of the abscissa 800 in this case again corresponds to the representation already explained above, while the cumulated inventories for a further exemplary supply chain with arbitrary normalization are plotted on the ordinate 801.

It can clearly be seen, for example from the great magnitude of the gradient of the regression line 803, that the cumulated inventories fall sharply in the period under consideration, which, at approximately nine weeks, is shorter in this case than the period considered in FIGS. 1 to 7.

The migration of the production installations in the supply chain to the method according to the invention first of all results in a slight increase in the inventories. Following a migration phase of, in this case, approximately four weeks, for example, this slight increase in the cumulated inventories changes to a sharp drop.

FIG. 9 shows an exemplary output from a display apparatus for the method according to the invention. It is clear to a person skilled in the art that it is an arbitrary form of representation that may turn out to be similar, the same or completely different for each supply chain and/or each production installation. In this case, the crucial parameters are shown, that is to say particularly the key date for an order t_{B} 11, referred to here as “Date to”, the date on which the method is carried, out t₀ 9, “Date From” here, the inventories, referred to as “Item” here and the designation of the product 6 or the components 7, 8, indicated both as a name and with the relevant number in the inventory list 16 in the case shown. In the present case, it is clearly a supply chain for beverages that is involved, it being clear to a person skilled in the art that alternatively any other supply chain and particularly other products 6, or components 7, 8, may be involved.

Instead of the inventories or in addition thereto, the quantity for the order or the cumulated number of units of the product 6 or the components 7, 8 thereof on the key date t_{B} 11 can also be indicated.

FIG. 10 shows a further exemplary embodiment of the method according to the invention. For two products 6, 6′, which in this case are denoted in the first column with their associated identification codes 04 and 25 in the inventory list 16, the net requirement is ascertained in accordance with the production planning, that is to say the order from the customer or OEM that was received by the key date t₀ for the method being carried out and the existent inventories, including any units in transit. To this end, the computer means 1 ascertains the total demand for the products 6, 6′, in this case shown in the second column, and the units that are existent within the supply chain in mobile depots (INTRANSIT), in this case 79 units for the first product 6 and 77 units for the second product 6′, and also the current inventories (QOH), in this case zero units each time, as shown in the fifth column. From this, the current total inventory is obtained, in accordance with the values indicated in the sixth column. By comparing the inventories for the production planning, the computer means ascertains the net requirement, or the net demand (NetDemand), in this case 886 and 4061 units, corresponding to a total requirement of 4947 units.

Next, the computer means 1 ascertains the components 7, 8 of the products 6, 6′ on the basis of the inventory list 16. In this case, on the next level of the supply chain, this corresponds to the component 7 with the identification code 60, in accordance with the statement in the first column (component) and first row of the second and third tables. By comparing the current total inventory (TotalStock), in this case in accordance with the statements in the sixth column of the third table, 975 units, with the total demand or the total requirement (TotalDemandBOM), the computer means 1 ascertains the net requirement (NetDemand). This is indicated in the seventh column of the third table in this case and corresponds to 3972 units in this case. In addition, the computer means 1 ascertains the excess inventory (DOH) of the component 7 by comparing the current total inventory with the average daily requirement or the average daily demand (AvgDailyDemand), which is indicated in the third column of the third table in this case. This is ascertained as an empirical value from the production planning, for example as a period-related average value.

In addition, the computer means 1 ascertains the current order quantity (ORDER_QTY), which is in this case indicated in the last column of the third table and corresponds to 5760 units in this case, from the production planning.

The comparison between the current order quantity resulting from the production planning and the net requirement reveals order errors. For example, the current order quantity is significantly above the net requirement in this case, specifically by 1788 units. Optionally, the computer means 1 then optimizes the production planning on the basis of the comparison between the current order quantity and the net requirement, for example by canceling orders or placing new orders, or adjusting the production of at least one production unit 13. In the long run, such adjustments result in evolution in a supply chain when the method according to the invention is applied, as described in connection with FIG. 4, for example.

The last table in FIG. 10 shows the situation for the next level of the supply chain, corresponding to the third table. The computer means 1 ascertains the subcomponents of the component 60 from the inventory list 16. In this case, this corresponds to the subcomponent with the identification code 99, in accordance with the statement in the first column of the last table. This subcomponent is used in the components 7, 8 indicated in the second table. From this, the computer means 1 ascertains the total demand for the subcomponent, in this case 2051.43 units, in accordance with the statements in the second table and in the second column of the last table.

In accordance with the method described above for the component 7, the computer means 1 ascertains the current total inventory, in this case 3187.51 units, and, by comparing the total demand with the current total inventory, the net demand or net requirement. This corresponds to 0 units in this case, since more units of the subcomponent are in stock than are required for the order. The computer means 1 will thus prompt no new orders for the subcomponent in this case.

The comparison between order quantities and net requirement allows order errors or less than optimum production planning to be easily identified.

FIG. 11 shows a further exemplary embodiment of the method according to the invention. In this case, the figure shows now the method according to the invention is used to ascertain a critical parameter for a supply chain, in this case the excess inventory 601, for example. The upper table indicates the desired product 6 or the desired component 7, 8, in this case an arbitrary product 6 with an identification code 399-5B8. This identification code can be used to find the product 6 in the materials list or inventory list 16. The computer means 1 identifies the product 6 in the materials list 16 and ascertains all associated components 7, 8. These are listed with their identification codes in the left-hand column of the lower table. The computer means 1 ascertains the production planning for the product 6 and the components 7, 8 thereof. Thus, by way of example, the computer means 1 ascertains the cumulated requirement in accordance with the cumulated order quantity on the key date t₀, which in this case corresponds to the date on which the method is carried out. This cumulated demand is indicated in the second column (TotalDemand). According to the embodiment shown, the computer means 1 also ascertains from the inventory list 16 the required number of components 7, 8 in order to produce a unit of the product 6 (MaterialQtyPerOne), and ascertains the total requirement in pieces of the individual components 7, 8 (TotalMaterialDemand) therefrom. In the example shown, the computer means 1 ascertains from this total requirement the average daily demand for the individual components 7, 8 (MatAvgDailDem). From this, the computer means 1 then ascertains the cumulated average daily demand, which corresponds to the average daily demand for the product 6 (MaterialAvgDailyDemand), in this case 1371.09 units.

In addition, the computer means ascertains the critical excess inventory for the whole supply chain. To this end, the computer means compares the cumulated inventory of each component 7, 8 and possibly each subcomponent with the respective ascertained average daily demand and therefore obtains the excess inventory 601 for each component 7, 8 or each subcomponent (DOH). This is shown in the last column in this case. The critical excess inventory for the whole supply chain corresponds in this case to the excess inventory 601 for the product 6, which is in turn the minimum of the individual excess inventory 601, that is to say 5.10 days in this case. This means that, if production planning or production is unaltered, at least one component 7, 8 will no longer be in stock in sufficient quantity on the sixth day, as a result of which further production is no longer possible from this instant. Hence, the method according to the invention allows a simple overview of production planning even in complex supply chains, since the production and production planning for the individual production units 16 in the supply chain can be altered, in particular optimized, on the basis of the ascertained excess inventory 601. In addition, it is therefore possible to ascertain erroneous production planning within the supply chain, since a disproportionately large excess inventory 601 indicates an unnecessarily large inventory.

The method according to the invention can be carried out either by the product manufacturer or by the component manufacturer, and plan their production and/or coordinate it with one another better and without delay. This firstly avoids significant costs as a result of too much or too little material ordered.

Secondly, the whiplash effect is also avoided, since the product orders can be viewed directly by all manufacturers in a supply chain. In addition, this also avoids long lead times and/or delays in production, which in turn leads to greater customer satisfaction and also directly and/or indirectly to higher returns.

In addition, the overview of the stock-keeping for the whole supply chain increases social control, since every part of the supply chain now has all the necessary information to optimize its own stock-keeping, as a result of which it is no longer possible for responsibilities to be shifted on.

Furthermore, the method according to the invention allows the demand-based or order-based excess inventories to be ascertained for any number of manufacturers in a supply chain, particularly manufacturers connected by means of supply agreements, as a result of which stock-keeping is simplified in a particularly simple and intuitive manner. In addition, it is particularly advantageous for the materials lists or inventory lists to be a standard variable for all computer means in the supply chain.

### LIST OF REFERENCE SYMBOLS

1 First computer means
2 Data connection
3 Database
4 Second computer means
5 Database
6 Product
7 Component 1
8 Component 2
9 Time t₀ (instant at which the method is carried out)
10 Time t_{L} (instant in production planning)
11 Time t_{B} (key date for an order)
12 Other system component
13 Production unit
14 Input means
15 Display apparatus
16 Inventory list
400, 500, 600, 700, 800 Time axis (in weeks)
401 Fluctuation/change in demand
501 Daily sales figures (index-based)
601 Excess inventory (in days)
701, 801 inventory (normalized)
402, 502, 602, 702, 802 Curve
403, 503, 603, 703, 803 Regression line

1. A method for stock-keeping and/or production optimization for at least one product and components thereof, wherein the product is manufactured from at least two components, comprising:
the provision of:
a first computer means that is connected to at least one first database by means of a data connection;
at least one second computer means that is connected to at least one second database by means of a data connection; wherein the second database is connected to the first computer means by means of a data connection and each second computer means is connected to the first database by means of a data connection, wherein the first and/or second databases has/have data about current inventory of the product and/or the components thereof and production planning therefor,
and at least the following steps:
each first computer means identifies all components of the product and the associated databases;
each first computer means ascertains the current inventory at a first time for the product and/or the components thereof;
each first computer means ascertains the production planning at a second time for the product and/or the components thereof;
each first computer means compares the current inventory at the first time and the production planning at the second time with at least one order at a third time for the product, which is present in the database and/or another system component connected to the computer means.

2. The method as claimed in claim 1, wherein each first computer means and/or each second computer means is connected to an input means that is used to input at least one of the data required in the method.

3. The method as claimed in claim 1, wherein each first computer means and/or each second computer means is connected to a display apparatus that is used to display one or more of the data ascertained in the method.

4. The method as claimed in claim 1, additionally comprising the following steps:
ascertainment of excess inventory at a current instant by each first computer means by means of the data ascertained in the method; and
storage of the excess inventory at the current instant in each first database and/or each second database by each first computer means.

5. A method for producing a vehicle interior trim part, having the method steps as claimed in claim 1, additionally comprising the following method steps:
each first computer means uses the data ascertained in the method to optimize the production planning and delivers the resulting data to each second computer means;
each first computer means and/or each second computer means transmits one or more data for production optimization to a respectively connected one or more production units.

6. The method as claimed in claim 5, wherein the production unit, in the event of the production unit having too little material in stock for the order to be completed as per the deadline and/or order, the production unit adjusts the production planning as appropriate by reordering material and/or increasing production.

7. The method as claimed in claim 5, wherein in the event of the production unit having too many products in stock after the order has been completed as per the deadline and/or order, the production unit adjusts the production planning as appropriate by running down production and/or canceling material reorder and/or deferring planned material reorders.

8. The method as claimed in claim 5, wherein the production unit communicates the process changes made to the directly connected first or second computer means, whereupon the first or second connected computer means transmits all or some of the process changes to the production units connected upstream and/or downstream and/or also connected in parallel.

9. The method as claimed in claim 5, wherein some or all of the data transmission is effected in encrypted form.

10. The method as claimed in in claim 1, wherein each first computer means and/or each second computer means is connected to a display apparatus and, in the event of an error in the course of the method, transmits an error message to the display apparatus.

11. The method as claimed in claim 1, wherein any access by each first computer means to each second database is preceded by additional method steps as follows:
each first computer means checks whether there is access authorization between the first computer means and the second computer means and/or the second database.

12. The method as claimed in claim 1, additionally comprising the following method steps:
each first computer means stores at least one of the data and/or states ascertained during the method in each first database and/or in each second database.
